(19) United States
(12) Patent Application Publication
(10) Pub. No.: US 2005/0185818 A1
(43) Pub. Date: Aug. 25, 2005

(54) Voice coil bobbin and speaker

(75) Inventors: Toshihiro Ishigaki, Tendo-shi (JP); Seiya Sato, Tendo-shi (JP); Yoshihide Goto, Sagae-shi (JP)

Correspondence Address: SUGHRUE MION, PLLC, 2100 PENNSYLVANIA AVENUE, N.W., SUITE 800, WASHINGTON, DC, 20037, US

(73) Assignees: PIONEER CORPORATION; TOHOKU PIONEER CORPORATION; GOTO DENSHI CO., LTD.

(21) Appl. No.: 11/063,550

(22) Filed: Feb. 24, 2005

(30) Foreign Application Priority Data
Feb. 24, 2004 (JP) P2004-47909

(51) Int. Cl. H04R 9/06; H04R 1/00

(52) U.S. Cl. 381/407; 381/410

(57) ABSTRACT

The bobbin of the voice coil bobbin is wound with a wrapper and a voice coil, wherein the wrapper has heat resistance against the heat generated in the voice coil and the wrapper makes contact with the voice coil.

### BACKGROUND OF THE INVENTION

1. Field of the Invention

The present invention relates to a voice coil bobbin and a speaker.

2. Description of the Related Art

Japanese Patent Application Laid-Open Publication No. Hei-07-75197 discloses that a conventional voice coil bobbin itself is manufactured from materials of resin impregnated fibers and there has been disclosed the technology in which the voice coil bobbin itself has heat resistance.

However, since the conventional voice coil bobbin described above was manufactured from special materials, it is quite expensive. Not only a portion of the voice coil bobbin that required heat resistance but also the whole voice coil bobbin are manufactured from special materials. Thus, the voice coil bobbin itself is heavy and, as a result, the output sound pressure of a speaker is reduced and the reproducibility of sounds is poor.

### SUMMARY OF THE INVENTION

In order to solve the problems described above, an object of the present invention is to provide a speaker which is less expensive, has high output sound pressure, and has the good reproducibility of sounds.

The present invention will be described below. Although reference numerals in the accompanying drawings will be accessorily written as parenthetic numerals for descriptive convenience, the present invention is not limited to the illustrated features.

The above object of the present invention can be achieved by a voice coil bobbin (7) having a bobbin (4) wound with a wrapper (5) and a voice coil (6), wherein the wrapper (5) has heat resistance against heat generated in the voice coil (6), and the wrapper (5) makes contact with the voice coil (6).

The above object of the present invention can be achieved by a voice coil bobbin (7) having a bobbin (4) wound with a wrapper (5) and a voice coil (6), wherein the wrapper (5) has heat resistance against heat generated in the voice coil (6), and at least a portion of the wrapper (5) is arranged between the bobbin (4) and the voice coil (6).

The above object of the present invention can be achieved by a voice coil bobbin (7) having a bobbin (4) wound with a wrapper (5) and a voice coil (6), wherein the voice coil (6) has a structure having a plurality of winding layers, the wrapper (5) has heat resistance against heat generated in the voice coil (6), and the wrapper (5) is arranged between the winding layers of the voice coil (6) having the plurality of winding layers.

### BRIEF DESCRIPTION OF THE DRAWINGS

FIG. 1 shows a cross sectional diagram of a speaker SP according to one embodiment of the present invention;

FIG. 2 shows a cross sectional diagram of a coil bobbin 7 according to one embodiment of the present invention;

FIG. 3 shows measured results on the coil bobbin 7 manufactured according to one embodiment of the present invention;

FIG. 4 shows results of the tensile strength test on samples;

FIG. 5 shows results of the bending test on samples; and

FIGS. 6A and 6B show examples of modified arrangement of a wrapper for a bobbin.

### DETAILED DESCRIPTION OF THE PREFERRED EMBODIMENTS

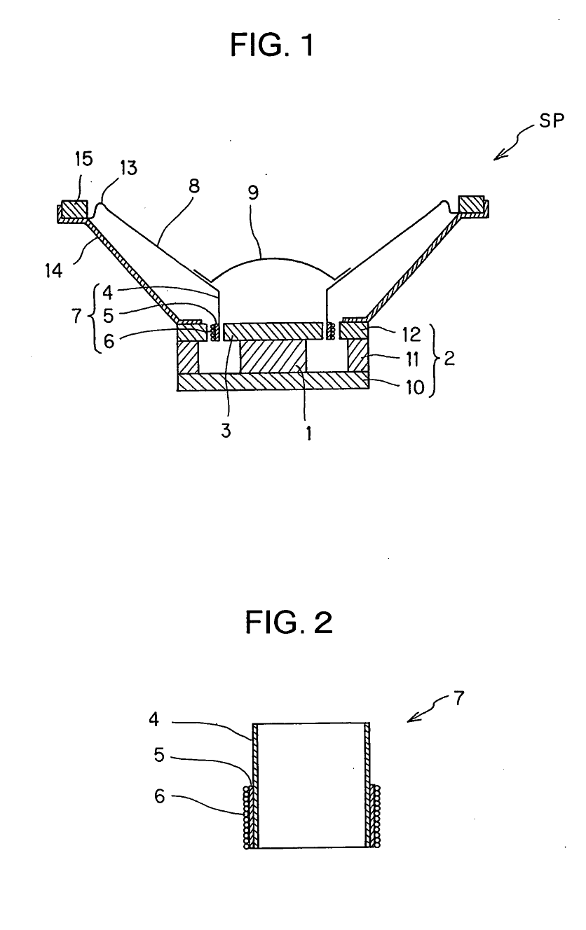

One embodiment of a speaker according to the present invention will be explained with reference to the drawings. FIG. 1 shows a cross sectional diagram of a speaker SP according to one embodiment of the present invention.

The speaker SP shown in FIG. 1 comprises a magnet 1, a yoke 2 which is provided at the bottom surface of the magnet 1, a center plate which is provided at the top surface of the magnet 1, a coil bobbin 7 which is constituted by winding a bobbin 4 with a wrapper 5 and a voice coil 6, a diaphragm 8, and a center cap 9.

Here, the magnet 1, for example, is consisted of a magnet with high magnetic flux density such as a neodymium magnet etc. and has a disk shape.

The yoke 2 comprises a bottom plate 10, a side wall portion 11, and a ring-shaped plate 12. The bottom plate 10, the side wall portion 11, and the ring-shaped plate 12, all are made of magnetic materials such as, for example, iron or its alloys or the like. A magnetic gap is formed between the inner peripheral surface of the ring-shaped plate 12 and the outer peripheral surface of the center plate 3, and this magnetic gap, the magnet 1, and the yoke 2 form a magnetic circuit.

The center plate 3, having a disk shape, is made of magnetic materials such as, for example, iron or its alloys or the like and is attached on the magnet 1.

The bobbin 4 is made of, for example, kraft paper, heat resistant plastics, or the like, and one end is fixed to the diaphragm 8 while the other end is wound with the wrapper 5 and the voice coil 6.

The wrapper 5 is made of materials having heat resistance such as non-woven fabrics of resin fibers or inorganic fibers, or resin coated cloths woven with resin fibers or inorganic fibers or the like, and winds around the bobbin 4.

The voice coil 6 is made of, for example, copper wires etc. and winds around the bobbin 4.

The coil bobbin 7 is constituted by winding the bobbin 4 with the wrapper 5 and the voice coil 6. The coil bobbin 7 locates the voice coil 6 at a predetermined position inside the magnetic gap. In addition, it propagates vibrations of the voice coil 6 to the diaphragm 8.

The diaphragm 8 is formed by, for example, paper making of paper pulp, injection molding of resins such as polypropylene etc., or press working of alloy thin sheets of aluminum, titanium, beryllium, or the like.

The diaphragm 8 is fixed to a frame 14 through an edge 13. Furthermore, a gasket 15 is provided at an installation portion around the periphery of the speaker SP. The edge 13 holds the diaphragm 8 at a predetermined position.

In the speaker SP having the structure described above, features of the present invention will be explained below.

FIG. 2 shows a cross sectional diagram of an extracted view of the coil bobbin 7 according to the present invention.

At the upper part of FIG. 2, one end of the coil bobbin 7 is fixed to the diaphragm 8, not shown in FIG. 2. At the opposite side of the side fixed to the diaphragm 8, the bobbin 4 is wound with the wrapper 5, and, on the wrapper, wound with the voice coil 6. In addition, the speaker SP is constructed so that the voice coil 6 is located inside the magnetic gap.

Here, for example, the speaker SP according to the present embodiment constitutes a speaker of the present invention, the bobbin 4 constitutes a bobbin of the present invention, the wrapper 5 constitutes a wrapper of the present invention, the voice coil 6 constitutes a voice coil of the present invention, and the coil bobbin 7 constitutes a coil bobbin of the present invention.

When the speaker SP having the structure described above receives voice signals, an electric current flows in the voice coil 6 located inside the magnetic gap. At this moment, the magnetic flux inside the magnetic gap and the current flowing in the voice coil 6 cause vibrations of the voice coil 6 with magnetic forces. These vibrations propagate to the diaphragm 8 through the bobbin 7, and vibrate the diaphragm 8, resulting in the generation of sounds.

[Embodiment 1]

Using data measured on a prototype of the speaker SP constructed according to the embodiment described above, the effect of the present invention will be explained below.

(Measurement Condition)

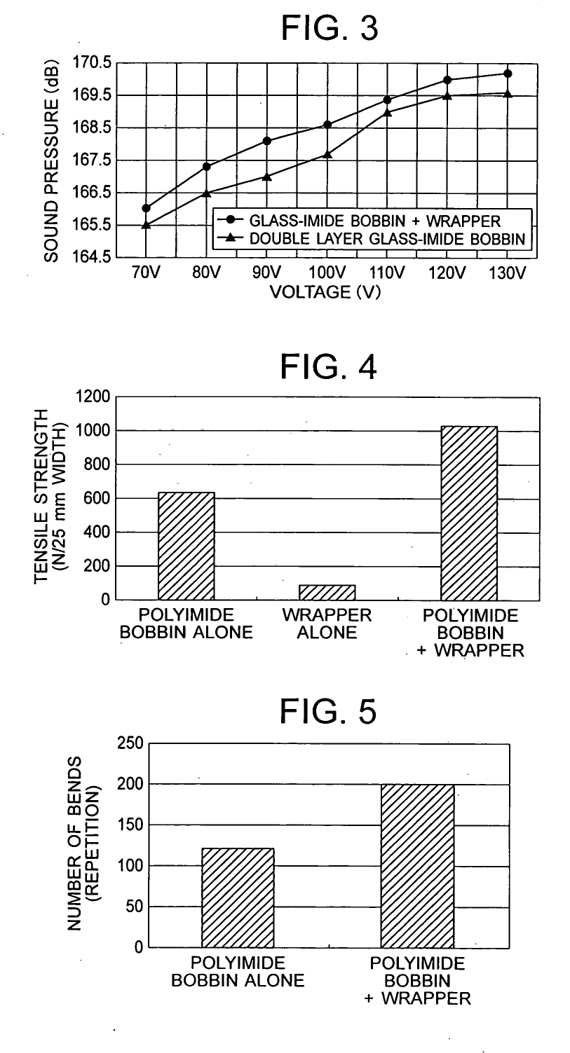

Actually, a bobbin made of a sheet of glass-imide (0.18 mm in thickness) was wound with a wrapper made by coating non-woven cloth of aramid fibers with polyimide resin as adhesives and a voice coil to form a coil bobbin. The coil bobbin thus formed was built into a subwoofer having an inner diameter of 30 cm, and the output sound pressure of the speaker was measured as a function of the input voltage. As a comparative experiment, a bobbin coil was manufactured by winding a bobbin made of a double layer of glass-imide (0.36 mm in thickness) with a voice coil. Results are shown in FIG. 3.

(Measurement Results)

FIG. 3 shows that the coil bobbin having one sheet of glass-imide wound with the wrapper had higher output sound pressure by 0.5 to 1.0 dB than that of the coil bobbin having 2 layers of glass-imide.

[Embodiment 2]

Next, by using data when the strength was measured for a bobbin bound with a wrapper, the effect of the present invention will be explained below.

A sample (25 mm in width) in which non-woven cloth of aramid fibers was glued on a sheet of glass-imide (0.18 mm in thickness) was used in tensile strength and bending tests. In the bending test, the number reciprocating bending at an angle of 90 degrees with a load of 1 kg was measured by which the sample developed cracks. Test results are shown in FIG. 4 and FIG. 5.

With regard to the tensile strength test results, it was found that the tensile strength was increased by approximately 40% by winding a wrapper. The tensile strength of a sample having a wrapper wound was higher than the sum of the tensile strength of a sheet of glass-imide alone and that of the wrapper alone. In general, a crack develops from the displacement of fibers of glass cloth consisting of glass-imide. When a wrapper was wound on a sheet of glass-imide, the fiber displacement of glass-imide was suppressed, and, as a result, the tensile strength was considered to be increased.

With regard to the result of the bending test, in the case of glass-imide alone, a crack developed at the 121st bending, but in the sample having a wrapper wound, a crack developed at the glass-imide side at the 200th bending.

The embodiments performed as described above have the following effects:

As shown in FIG. 2, since there is provided a wrapper 5 having heat resistance between the bobbin 4 and the voice coil 6, the heat generated in the voice coil by the input current does not propagate to the bobbin 4 at the original source temperature. Therefore, the bobbin can be made thin, and thus the coil bobbin can be made light. As a result, since the output sound pressure of the speaker can be made large, the reproducibility of sounds is improved.

Since it is possible to arrange the wrapper 5 having heat resistance only near the voice coil 6 which requires heat resistance, it is not required to manufacture the whole bobbin 4 with heat resistant materials. Therefore, the bobbin can be manufactured less expensively and the manufacturing cost of the speaker can be made less expensive.

Since the density of the wrapper is low compared with the bobbin, it is possible to reduce the weight of the coil bobbin by winding the wrapper instead of increasing the number of winding layers of the bobbin while keeping the heat resistance constant.

It is possible to wind the wrapper only around the place where the heat resistance is required. Thus, it is possible to make the weight of the whole coil bobbin light.

When the heat resistance is secured by making the bobbin thicker, the outer dimension of the voice coil becomes large. As a result, since it is necessary to make the magnetic gap large, the magnetic efficiency becomes poor.

When the voice coil is wound on the wrapper, the voice coil penetrates into the wrapper. Thus, it is possible to make the magnetic gap narrower without making the outer diameter of the voice coil large. As a result, it is possible to improve the magnetic efficiency.

When the voice coil is wound on the wrapper, the voice coil penetrates into the wrapper. Thus, even when the adhesive strength is reduced by softening of the surface adhesive layer due to the high temperature of the voice coil caused by large input current, the voice coil hardly falls off because of its penetration into the bobbin. Therefore, the durability of the coil bobbin and the speaker is improved.

By gluing the wrapper on the bobbin, the tensile strength and the anti-bending strength of the coil bobbin are improved. Therefore, the durability of the coil bobbin and the speaker is improved.

Furthermore, an embodiment of the present invention is not limited to the embodiments described above, and, for example, it may be modified as described below.

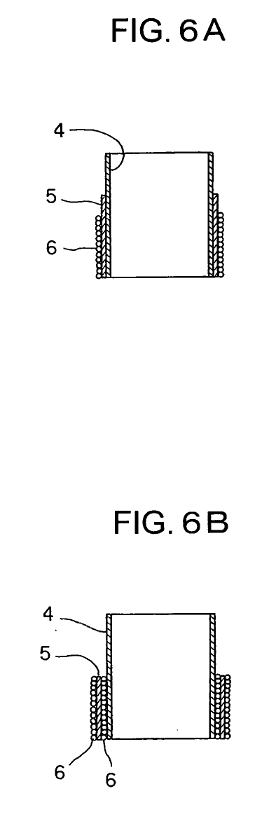

The arrangement of the wrapper 5 with respect to the bobbin 4 is not limited to the example shown in FIG. 2. For example, a structure, in which the voice coil is not wound on a portion of the wrapper, may be adopted (FIG. 6A). In this case, when the wrapper 5 is composed of materials having high thermal conductivity such as metallic fibers, heat generated in the voice coil 6 can be air cooled through the portion of the wrapper 5 where the voice coil 6 is not wound. When the voice coil 6 has a plurality of winding layers, the wrapper 5 may be arranged between the layers of the voice coil 6 having the plurality of winding layers (FIG. 6B). It is possible to insulate the heat between the winding layers of the voice coil 6. Since the voice coil 6 penetrates into the wrapper 5, the voice coil hardly falls off.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2004-47909 filed on Feb. 24, 2004 including the specification, claims, drawings and summary is incorporated herein by reference in its entirety.

1. A voice coil bobbin having a bobbin wound with a wrapper and a voice coil, wherein
the wrapper has heat resistance against heat generated in the voice coil, and
the wrapper makes contact with the voice coil.

2. The voice coil bobbin according to claim 1, wherein the wrapper is wound at a portion of the bobbin where the voice coil is not wound.

3. A voice coil bobbin having a bobbin wound with a wrapper and a voice coil, wherein
the wrapper has heat resistance against heat generated in the voice coil, and
at least a portion of the wrapper is arranged between the bobbin and the voice coil.

4. The voice coil bobbin according to claim 3, wherein at least a portion of the wrapper is wound at a portion of the bobbin where the voice coil is not wound.

5. A voice coil bobbin having a bobbin wound with a wrapper and a voice coil, wherein
the voice coil has a structure having a plurality of winding layers,
the wrapper has heat resistance against heat generated in the voice coil, and
the wrapper is arranged between the winding layers of the voice coil having the plurality of winding layers.

6. The voice coil bobbin according to claim 1, wherein the wrapper is made of any one selected from the group consisting of (a) non-woven fabrics of resin fibers, (b) non-woven fabrics of inorganic fibers, and (c) resin coated cloth woven with either resin fibers or inorganic fibers.

7. The voice coil bobbin according to claim 3, wherein the wrapper is made of any one selected from the group consisting of (a) non-woven fabrics of resin fibers, (b) non-woven fabrics of inorganic fibers, and (c) resin coated cloth woven with either resin fibers or inorganic fibers.

8. The voice coil bobbin according to claim 5, wherein the wrapper is made of any one selected from the group consisting of (a) non-woven fabrics of resin fibers, (b) non-woven fabrics of inorganic fibers, and (c) resin coated cloth woven with either resin fibers or inorganic fibers.

9. A speaker using the voice coil bobbin according to claim 1.

10. A speaker using the voice coil bobbin according to claim 3.

11. A speaker using the voice coil bobbin according to claim 5.
